(19) United States
(12) Patent Application Publication
(10) Pub. No.: US 2024/0068432 A1
(43) Pub. Date: Feb. 29, 2024

(54) GAS INJECTOR HAVING REDUCED WEAR

(71) Applicant: ROBERT BOSCH GMBH, Stuttgart (DE)

(72) Inventor: Martin Mueller, Moeglingen (DE)

(21) Appl. No.: 18/260,363

(22) PCT Filed: Nov. 18, 2021
(86) PCT No.: PCT/EP2021/082055

§ 371 Date: Jul. 26, 2023

(30) Foreign Application Priority Data
Dec. 21, 2020 (DE) 102020216404.5

(51) Int. Cl. F02M 51/06; F02M 21/02

(52) U.S. Cl. CPC F02M 51/0675; F02M 21/0254; F02M 21/0269

(57) ABSTRACT

A gas injector for injecting a gaseous fuel. The gas injector includes a magnetic actuator having an armature, an inner pole, and a coil; a closing element, which releases and closes a gas path at a valve seat, the armature being connected to the closing element; a sealed lubricant chamber, which is filled with a lubricant and in which the armature is situated, the lubricant ensuring a lubrication of the armature; and a first flexible sealing element and a second flexible sealing element, which seal the lubricant chamber from the gas path.

### FIELD

The present invention relates to a gas injector for injecting a gaseous fuel, especially hydrogen or natural gas or a similar substance, with less wear, in particular for internal combustion engines. The gas injector is especially configured for a direct injection into a combustion chamber of an internal combustion engine.

### BACKGROUND INFORMATION

Gas injectors in different developments are described in the related art. As a matter of principle, gas injectors have a variety of problems insofar as it is impossible because of the gaseous medium to be injected to provide lubrication by the medium, whereas lubrication by the medium is possible in the case of fuel injectors which inject gasoline or diesel, for instance. This causes excessive wear during an operation in comparison with fuel injectors for liquid fluids. It would therefore be desirable to have a gas injector which offers a better wear behavior.

### SUMMARY

In contrast, the gas injector for injecting a gaseous fuel according to the present invention may offer the advantage that wear of the gas injector is able to be significantly reduced. This extends the service life of the gas injector and essentially corresponds to the service life of a fuel injector for liquid fuels. According to an example embodiment of the present invention, this may be achieved in that the gas injector has a lubricant which is accommodated in a sealed lubricant chamber which houses movable parts of the gas injector. The gas injector includes a magnetic actuator provided with an armature, an inner pole and a coil.

According to an example embodiment of the present invention, the armature, which is mechanically connected to a closing element which releases and closes a gas path at a valve seat, is provided to allow for an opening and/or closing movement of the injector. The armature situated in the lubricant chamber, which is pulled counter to the inner pole of the magnetic actuator as a result of electromagnetic forces when the coil is energized, thus is located in the interior of the lubricant chamber and is supplied with lubricant and continuously lubricated. This significantly reduces wear at the armature in comparison with the gas injectors currently available in the related art. The armature around which lubricant is flowing is damped in its movement when it strikes the inner pole, so that the momentum transmitted to the inner pole by the armature is lower than without the lubricant. This injector is therefore less noisy than an injector without lubricant. To ensure sealing of the lubricant chamber, a first and second flexible sealing element are provided which seal the lubricant chamber in subregions. Moreover, the service life of the gas injector may be significantly extended by the use of the sealed lubricant chamber filled with lubricant. The lubricant preferably fills the entire lubricant chamber.

As a result, the lubricant chamber is sealed with the aid of two flexible sealing elements, thereby making it possible to prevent the generation of a disadvantageous excess pressure or negative pressure, which may exert an undesired force on the closing element of the gas injector, such as via components of the lubricant chamber, in a displacement of the lubricant in the lubricant chamber. Even if a disadvantageous force is exerted on one of the sealing elements, which may lead to a pressure rise or pressure drop in the sealed lubricant chamber, the provision of two flexible sealing elements makes it possible to compensate for the pressure change with the aid of the second flexible sealing element. An undesired pressure drop or pressure rise in the interior of the sealed lubricant chamber may therefore be successfully prevented.

Preferred refinements and example embodiment of the present invention are disclosed herein.

Furthermore, according to an example embodiment of the present invention, the gas injector preferably includes a preloaded spring, which exerts a predefined external force on the lubricant in the sealed lubricant chamber. Preferably, an excess pressure of between 0.5 to 10×10⁵ Pa, especially preferably 1 to 5×10⁵ Pa, is exerted in the process. The lubricant in the lubricant chamber is therefore able to be brought to a predefined pretension so that undesired deformations which could affect the lift of the closing element are able to be reliably prevented.

Especially preferably, according to an example embodiment of the present invention, the first flexible sealing element is a first bellows, and the second flexible sealing element is a second bellows. It is furthermore preferred that the first and second bellows have an identical development, which means that they have the same mean bellows diameter and the same number of bellows folds. This particularly makes it possible to reduce the production costs of the gas injector.

Moreover, according to an example embodiment of the present invention, via a plate, the second bellows is connected by a guide pin to the preloaded spring. In this way, a simple and cost-effective design is realizable. In addition, a certain pretension can be exerted directly on the second bellows with the aid of the preloaded spring, thereby generating the excess pressure in the storage chamber.

According to a further preferred embodiment of the present invention, the gas injector also has a first and a second closing-element guide. The first and second closing-element guides are preferably both situated in the storage chamber. The closing element preferably has only the two first and second closing-element guides so that all guide elements for the closing element are situated in the interior of the lubricant chamber filled with lubricant. This ensures the lubrication of all important components of the gas injector in the interior of the lubricant chamber. In practice, the service life of the gas injector may therefore correspond to the service life of an injector for liquid fuels.

According to a further preferred embodiment of the present invention, the preloaded spring is situated within the second bellows. The lubricant chamber thus extends radially outside the second bellows and is restricted by a housing component. A more compact design, in particular in an axial direction of the gas injector, is consequently achievable because the preloaded spring is situated in the interior of the second bellows.

Moreover, according to an example embodiment of the present invention, a brake device is preferably situated in the lubricant chamber, which is designed to decelerate the closing element in a restoring operation of the closing element. This allows for a further reduction of the wear at the valve seat because the deceleration of the closing element in a restoring operation makes it possible to reduce an impact of the closing element on the valve body seat. The brake device is able to reduce the momentum when the closing element strikes the valve seat body, in particular because the valve seat is normally very dry and sits in the hot combustion chamber atmosphere.

The brake device preferably includes a brake stud and an elastic brake element such as a spring or an elastic component. During the restoring operation, the brake stud is able to be brought into an effective connection with the armature and/or the closing element so that the armature strikes the brake stud before its actual impact on the stop and moves the brake stud against the force of the elastic element, so that damping of the armature during the restoring operation is possible. More specifically, a restoring speed of the armature is reduced. This is also aided by the acceleration of the additional masses provided by the brake device. Via the displacement of the lubricant between the armature and the brake stud, a further deceleration is also achieved. An additional reduction in the restoring speed of the closing element can also be realized by friction of guide elements or the like with the brake stud. All of this reduces the impact force of the armature at the stop, which means that a further extension of the service life of the armature can be achieved.

Especially preferably, according to an example embodiment of the present invention, a brake guide element, which ensures a stable movement of the guide bolt, is situated at the brake stud. However, friction can additionally be generated by the brake guide element during the restoring operation of the closing element, which provides a damping function in addition.

In the closed state of the injector, an axial gap B between the brake guide element and the brake stud is preferably smaller than an axial gap C between the armature and the inner pole. Axial gap B between the brake guide element and the brake stud lies in a range of 1% to 90% of axial gap C between the armature and the inner pole. Especially preferably, axial gap B between the brake guide element and brake stud is smaller than 25% of axial gap C, and furthermore preferably lies in a range of 3% to 10% of axial gap C. The axial gap C preferably has a size of 0.05 mm to 3 mm, especially 0.8 mm.

Oil, in particular mineral oil, synthetic hydrocarbon oil, ester oil or polyglycol oil, is preferably used as the lubricant. A liquid fuel is used as an alternative, in particular diesel or gasoline. Another alternative is the use of grease as a lubricant.

In addition, according to an example embodiment of the present invention, the first and second flexible sealing elements are preferably single-layer or multilayer bellows. The bellows is preferably made of metal or from plastic as an alternative. At a first end, the first bellows is preferably fixed in place directly on the closing element and at another end, on a housing component of the gas injector. For metal bellows, this fastening may be realized with the aid of a welding seam.

As an alternative, according to an example embodiment of the present invention, the first and second flexible sealing element is a diaphragm or a rubber element in each case. The diaphragm may have one layer or multiple layers and, for instance, be fixed in place on the respective components for sealing the lubricant chamber with the aid of laser welding.

According to an example embodiment of the present invention, a gas path of the gaseous fuel is preferably provided in a region between a valve housing of the gas injector and an actuator housing of the gas injector. This allows the actuator to be placed in a housing and to be at least partly preinstalled as a subassembly. This also makes it relatively easy to position the lubricant chamber in the interior of the actuator housing.

As an alternative, according to an example embodiment of the present invention, the gas path of the gaseous fuel is developed through a region of the magnetic actuator, in particular through the coil space in which the coil of the magnetic actuator is situated. A separate actuator housing for the magnetic actuator may thus be dispensed with. Especially preferably, an electrical contacting is then routed through the gas path of the gaseous fuel. This may reduce the complexity of the design of the gas injector, in particular. It should be noted that the electrical contacting leading through the gas space must of course be sealed from the external environment.

In addition, according to an example embodiment of the present invention, a filter for the gaseous fuel is preferably situated in the gas path in order to filter out solid particles that may be present in the gaseous fuel or to filter out solid particles resulting from the production or installation. Moreover, a guide component is preferably also provided on the closing element, especially if the closing element is a long valve needle.

According to an example embodiment of the present invention, The gas injector is preferably an outwardly opening injector.

Furthermore, the gas injector is preferably balanced in terms of the pressure force. This makes the force for opening the gas injector with the aid of the magnetic actuator independent of the gas pressure. The time for opening and closing the injector after the start of an energization or at the end of an energization is thus likewise independent of the gas pressure. This in turn allows for an operation at different gas pressures. Given a desired small injection quantity, the gas pressure may be reduced, and if a large injection quantity is desired, the gas pressure may be raised. The injector is pressure-force-balanced when the mean diameter of the bellows is equal to the diameter of the seat-contact line between the closing element and the valve body. However, the mean bellows diameter may also be selected smaller or larger than the seat diameter. In the former case, the entire closing force on the valve needle is reduced at a higher gas pressure and the injector opens more rapidly in an energization and closes more slowly following the energization. This results in a greater injected gas quantity. In the second case, the closing force on the valve needle becomes greater at a higher gas pressure. This in turn may compensate for an increase in the seat leakage quantity by the higher gas pressure.

According to an example embodiment of the present invention, a restoring is preferably implemented with the aid of a restoring spring. In an injector which is balanced in terms of the pressure force, there is particularly no pressure force acting on the valve needle in the opening direction by the gaseous fuel in the closed state of the gas injector, which means that the load on the closing element can be significantly reduced.

### BRIEF DESCRIPTION OF THE DRAWINGS

In the following text, exemplary embodiments of the present invention are described in detail with reference to the figures.

FIG. 1 shows a schematic sectional view of a gas injector according to a first exemplary embodiment of the present invention.

FIG. 2 shows a schematic sectional view of a gas injector according to a second exemplary embodiment of the present invention.

FIG. 3 shows a further schematic, enlarged part-sectional view of a gas injector according to a third exemplary embodiment of the present invention.

### DETAILED DESCRIPTION OF EXAMPLE EMBODIMENTS

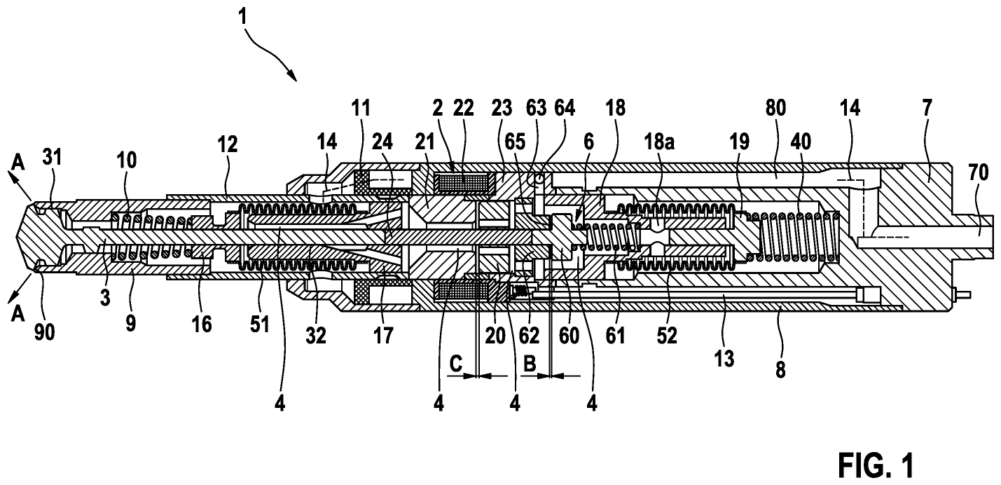

In the following text, a gas injector 1 according to a first preferred exemplary embodiment of the present invention is described in detail with reference to FIG. 1.

As may be gathered from FIG. 1, gas injector 1 for the injection of a gaseous fuel includes a magnetic actuator 2, which moves a closing element 3—in this exemplary embodiment an outwardly opening valve needle—from a closed state to an open state. FIG. 1 depicts the closed state of the gas injector.

Magnetic actuator 2 includes an armature 20, which rests against closing element 3 with the aid of an armature bolt 24. In addition, magnetic actuator 2 has an inner pole 21, a coil 22, and a magnetic housing 23, which ensures a magnetic reflux of the magnetic actuator.

In addition, gas injector 1 has a main body 7 provided with a connection pipe 70 through which the gaseous fuel is supplied. A valve housing 8 inside which magnetic actuator 2 is situated is fixed in place on main body 7. Positioned next to valve housing 8 is a valve body 9 at whose free end a valve seat 90 is provided in which closing element 3 releases and closes a passage for the gaseous fuel.

FIG. 1 schematically shows an electric connection 13, which is routed through main body 7 to magnetic actuator 2.

A holding body 12 is provided to fasten inner pole 21 to valve body 9.

Reference numeral 10 denotes a restoring element for closing element 3 to return it to the closed state shown in FIG. 1 after an opening operation.

In addition, a gas flow as a gas path 14 through gas injector 1 is shown in FIG. 1. The gas flow begins at the connection pipe, from where it is then rerouted by 90° into an annular space 80 between valve housing 8 and main body 7. Gas flow 14 continues past an external region of magnetic actuator 2 through a filter 11 in the region of closing element 3 until it arrives in front of valve seat 90. Through-openings are provided in the respective components for this purpose, which are not shown in the figures.

When gas injector 1 is opened, the gaseous fuel flows along the outer periphery of magnetic actuator 2 and open sealing seat 90 into a combustion chamber of an internal combustion machine, which is sketched by the arrow A in FIG. 1.

Closing element 3 thus releases and closes a gas path at valve seat 90. For guidance, a first guide region 31 is provided on valve body 9 and a second guide region 32 is provided between closing element 3 and a valve needle guide 17, as may be gathered in more detail from FIG. 1.

In addition, gas injector 1 has a sealed lubricant chamber 4. Sealed lubricant chamber 4 is completely or partially filled with lubricant such as oil. Second guide region 32 is situated within lubricant chamber 4.

As may be gathered from FIG. 1, lubricant chamber 4 is defined by a first flexible sealing element 51, valve needle guide 17, inner pole 21, a magnetic housing 23, a storage body 18, and a second flexible sealing element 52. First and second flexible sealing elements 51, 52 are developed as bellows in each case. First and second flexible sealing element 51, 52 have an identical development.

As may furthermore be gathered from FIG. 1, second flexible sealing element 52 is fixed in place on a plate 19 including a guide pin, for instance with the aid of a welding seam. Gas injector 1 also has a preloaded spring 40, which is supported on main body 7 and pretensions second flexible sealing element 52 via plate 19. Transverse bores 18a are provided in storage body 18 so that the lubricant held in lubricant chamber 4 is also present in the region within second flexible sealing element 52.

First flexible sealing element 51 is fixed in place on a spring plate 16 which is connected to closing element 3 and to valve needle guide 17 at the other end. Restoring element 10 is braced on spring plate 16, which is firmly connected to closing element 3.

Lubricant chamber 4 thus has two flexible sealing elements 51, 52 as well as preloaded spring 40. Preloaded spring 40 exerts a certain pretension, e.g., 1×10⁵ Pa, on the lubricant situated inside lubricant chamber 4. If in an opening operation a displacement of lubricant occurs to the left due to the lift of closing element 3 or also due to cold shrinkage or by a thermal expansion of the lubricant, then a negative pressure or an excess pressure, which may possibly be created in the interior of lubricant chamber 4, is able to be compensated for by a deflection at second flexible sealing element 52 in conjunction with an expansion or contraction of preloaded spring 40. Thus, an undesired force acting on closing element 3 via the effective surface of the bellows is avoidable with the aid of flexible sealing element 51.

Armature bolt 24 with armature 20 fixed thereon is situated in sealed lubricant chamber 4. Because lubricant chamber 4 is filled with a lubricant such as a liquid fuel, e.g., gasoline or diesel or grease or the like, a continuous lubrication of armature 20 is provided. This therefore makes it possible to compensate for the problems with gaseous fuels encountered in the related art, that is, the lack of lubrication of the moved parts.

As may be gathered from FIG. 1, a fill channel 63 is provided for filling sealed lubricant chamber 4. A sealing ball 64 seals fill channel 63 in a fluid-tight manner.

In addition, a brake device 6 is situated in sealed lubricant chamber 4. Brake device 6 includes a brake stud 60, a brake spring 61, and a brake guide element 62. Brake guide element 62 guides brake stud 60 and is positioned at an inner periphery of magnetic housing 23.

Via armature bolt 24, brake stud 60 is in an effective connection with the armature. Brake spring 61 is situated between brake stud 60 and storage body 18.

Brake device 6 has the task of decelerating closing element 3 together with armature 20 in a closing operation of gas injector 1. On the one hand, the deceleration is implemented via the brake spring force by brake spring 61 at brake stud 60, and by an hydraulic adhesion to an axial contact surface 65 between brake stud 60 and stationary brake guide element 62 (see FIG. 1) when brake stud 60 lifts off from axial contact surface 65, on the other hand.

During the restoring of closing element 3, the closing element is furthermore decelerated by the friction in brake guide element 62, into which armature bolt 24 also partially projects. Moreover, the masses to be accelerated and the displacement of the lubricant in sealed lubricant chamber 4 lead to a further deceleration during the closing operation.

As can gathered from FIG. 1, an axial gap C is provided between armature 20 and inner pole 21 in the closed state. An axial gap B is provided between brake stud 60 and brake guide element 62. Axial gap C between armature 20 and inner pole 21 preferably lies in a range of 0.05 to 3 mm and especially preferably amounts to 0.3 mm to 1 mm. When coil 22 is energized, armature 20 is pulled counter to inner pole 21, which brings closing element 3 into the opening state via armature bolt 24 and thus allows for the flow of gaseous fuel into the combustion chamber. It should be noted that in order to reduce a magnetic leakage flux, armature bolt 24 and/or sleeve-shaped valve needle guide 17, in particular, is/are made from non-magnetizable materials.

Axial gap B between brake stud 60 and brake guide element 62 is smaller than gap C between armature 20 and inner pole 21 and is also closed during the opening operation by the spring force of brake spring 61. Gap B preferably amounts to between 1% and 90% of gap C. This realizes the hydraulic adhesion of brake stud 60 to brake guide element 62 during the restoring operation.

Gas injector 1 shown in FIG. 1 is balanced in terms of the pressure force. This means that closing element 3 is connected to first flexible sealing element 51 via spring plate 16, first flexible element 51 being developed as metal bellows and having a mean diameter which is equal to a diameter at valve seat 90 where closing element 3 provides sealing at valve body 9. As a consequence, there results no pressure force on closing element 3 so that a magnetic force required to open closing element 3 is able to be kept very low and is independent of a pressure of the gaseous fuel, in particular.

It should be noted that instead of the bellows, it is also possible, for instance, to use a diaphragm or a hose or a rubber element or the like as flexible sealing elements 51, 52.

Thus, gas injector 1 is able to provide reduced wear on the moved parts, in particular at valve seat 90, armature 20, and in armature bolt 24. In addition, a heat dissipation from magnetic actuator 2 may be considerably improved by sealed lubricant chamber 4 including a liquid lubricant. Through the two flexible sealing elements 51, 52 it can furthermore be prevented that undesired forces act on closing element 3.

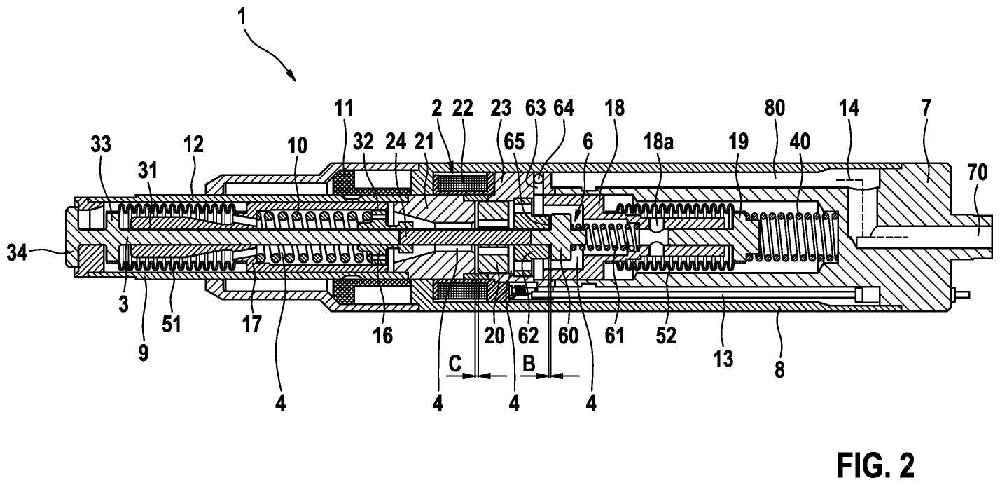

FIG. 2 shows a gas injector 1 according to a second exemplary embodiment of the present invention. Identical or functionally equivalent parts are denoted in the same way as in the first exemplary embodiment.

As may be gathered from FIG. 2, the development of gas injector 2 is basically identical to that of the first exemplary embodiment. In contrast thereto, however, lubricant chamber 4 in the second exemplary embodiment is provided in a different form. As illustrated in FIG. 2, first guide region 31 and second guide region 32 are situated in the interior of lubrication space 4. First guide region 31 is positioned on a valve needle guide and second guide region 32 is disposed on spring plate 16. This also allows for the lubrication of both guide regions 31, 32 by the lubricant held in lubricant chamber 4. In addition, closing element 3 has an annular flange 33 on which first flexible sealing element 51 is fixed in place. At the other end, first flexible sealing element 51 is fixed in place on valve needle guide 17. As can be gathered from FIG. 2, restoring element 10 is also situated in lubricant chamber 4 and braced on valve needle guide 17. Even more moved parts are therefore situated in lubricant chamber 4 in the second exemplary embodiment, so that wear of the gas injector of the second exemplary embodiment is able to be reduced further.

In all other respects, this exemplary embodiment corresponds to the first exemplary embodiment so that reference can be made to the description there.

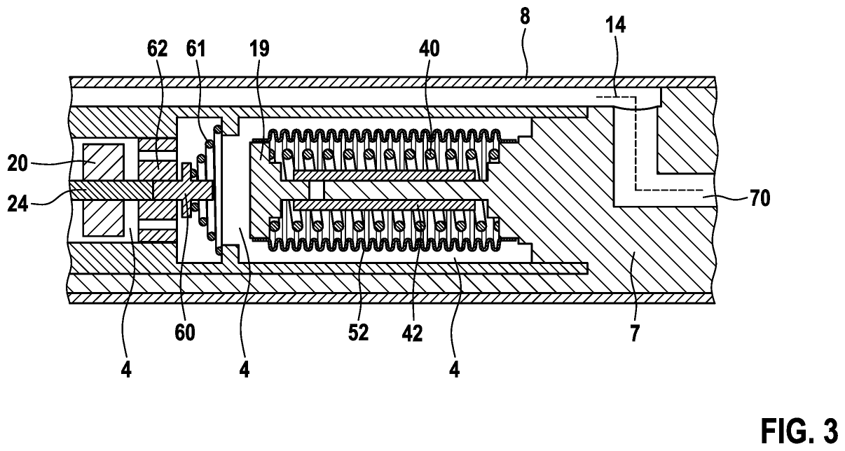

FIG. 3 shows details of a gas injector 1 according to a third exemplary embodiment, where identical or functionally equivalent parts have once again been provided with the same reference numerals as in the above-described exemplary embodiments. The third exemplary embodiment is able to be combined with the first exemplary embodiment or the second exemplary embodiment. As may be gathered from FIG. 3, the third exemplary embodiment has been modified in the region of second flexible sealing element 52. As depicted in FIG. 3, preloaded spring 40 is disposed in the interior of second flexible sealing element 52 developed as a bellows. The lubricant is located radially outside of second flexible sealing element 52. Preloaded spring 40 is braced on spring plate 19, which also restricts lubricant chamber 4, and main body 7. A sleeve 42 is provided to guide spring plate 19. An axial length of gas injector 1 is therefore able to be reduced by the positioning of preloaded spring 40 in the interior of second flexible sealing element 52. A further difference in the third exemplary embodiment is that brake spring 61 of the third exemplary embodiment is a cone-shaped helical pressure spring. In this way, a further reduction in the axial length of gas injector 1 can be achieved.

In all other respects, the third exemplary embodiment corresponds to the first and second exemplary embodiments so that reference may be made to the description provided there.

1-11. (canceled)

12. A gas injector for injecting a gaseous fuel, comprising:
a magnetic actuator having an armature, an inner pole, and a coil;
a closing element, which releases and closes a gas path at a valve seat, the armature being connected to the closing element;
a sealed lubricant chamber which is filled with a lubricant and in which the armature is situated, the lubricant ensuring a lubrication of the armature; and
a first flexible sealing element and a second flexible sealing element which seal the lubricant chamber from the gas path.

13. The gas injector as recited in claim 12, further comprising:
a preloaded spring, which exerts a predefined external force on the lubricant in the sealed lubricant chamber.

14. The gas injector as recited in claim 12, wherein the first flexible sealing element is a first bellows, and the second flexible sealing element is a second bellows.

15. The gas injector as recited in claim 14, wherein the second bellows is connected to the preloaded spring via a plate.

16. The gas injector as recited in claim 14, wherein the first bellows has the same mean diameter as the second bellows and the same number of bellows folds.

17. The gas injector as recited in claim 12, further comprising:
at least two guide regions for guiding the closing element, which are both situated in the lubricant chamber.

18. The gas injector as recited in claim 15, wherein the preloaded spring is situated within the second flexible sealing element, and the lubricant chamber is located outside the second flexible sealing element.

19. The gas injector as recited in claim 12, wherein a brake device is situated in the lubricant chamber, which is configured to decelerate the closing element in a restoring operation of the gas injector from the open to the closed state.

20. The gas injector as recited in claim 19, wherein the brake device has a brake stud and an elastic brake element, the brake stud and the elastic brake element being able to be brought into an effective connection with the closing element and/or the armature during the restoring operation.

21. The gas injector as recited in claim 20, wherein the brake stud is guided in a brake guide element in the lubricant chamber.

22. The gas injector as recited in claim 21, wherein in a closed state of the injector, a first axial gap between the brake guide element and the brake stud is smaller than a second axial gap between the armature and the inner pole.
